(19) United States
(12) Patent Application Publication
(10) Pub. No.: US 2008/0279064 A1
(43) Pub. Date: Nov. 13, 2008

(54) Optical Data Storage System and Method of Optical Recording and/or Reading

(75) Inventors: Martinus Bernardus Van Der Mark, Eindhoven (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,991

(22) PCT Filed: Apr. 15, 2005
(86) PCT No.: PCT/IB05/51244

§ 371 Date: Oct. 17, 2006

(30) Foreign Application Priority Data
Apr. 20, 2004 (EP) 04101633.8

(51) Int. Cl. G11B 5/09; G11B 7/135

(52) U.S. Cl. 369/47.36; 369/112.23; 369/112.01

(57) ABSTRACT

An optical data storage system for recording and/or reading, using a radiation beam having a wavelength X is described. The radiation beam is focused onto a data storage layer of an optical data storage medium. The medium has a cover layer that is transparent to the focused radiation beam. The cover layer has a thickness h smaller than 5 μm. A cover layer with thickness variation of substantially less than the focal depth, i.e. 50 nm, eliminates the need of dynamic focus control of the objective which is otherwise required in addition to the gap servo. Further a method of optical recording is described using such an optical data storage system by which a static focus control and spherical aberration correction to accommodate medium-to-medium variance is achieved. The static focus control can be realised by optimising the modulation depth of a known signal, e.g. from a lead-in track.

The invention relates to an optical data storage system for recording and/or reading, using a radiation beam having a wavelength λ, focused onto a data storage layer of an optical data storage medium, said system comprising:
the medium having a cover layer that is transparent to the focused radiation-beam, said cover layer having a thickness h smaller than 5 μm,
an optical head, including an objective having a numerical aperture NA, said objective including a solid immersion lens that is adapted for being present at a free working distance of smaller than λ/10 from an outermost surface of said medium and arranged on the cover layer side of said optical data storage medium, and from which solid immersion lens the focused radiation beam is coupled by evanescent wave coupling into the cover layer of optical data storage medium during recording/reading.

The invention further relates to a method of optical recording and/or reading with such a system.

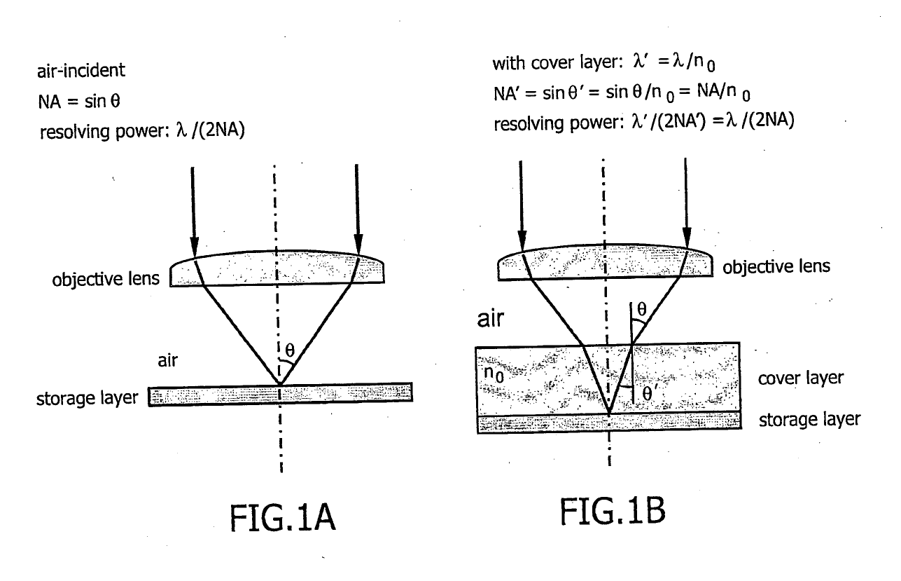

A typical measure for the focussed spot size or optical resolution in optical recording systems is given by r=λ/(2NA), where λ is the wavelength in air and the numerical aperture of the lens is defined as NA=sin θ, see FIG. 1. In FIG. 1A, an air-incident configuration is drawn in which the data storage layer is at the surface of the data storage medium, so-called first-surface data storage. In FIG. 1B, a cover layer with refractive index n₀ protects the data storage layer from a.o. scratches and dust.

From these figures it is inferred that the optical resolution is unchanged if a cover layer is applied on top of the data storage layer: On the one hand, in the cover layer, the internal opening angle θ′ is smaller and hence the internal numerical aperture NA′ is reduced, but also the wavelength in the medium λ′ is shorter by the same factor n₀. It is desirable to have a high optical resolution because the higher the optical resolution, the more data can be stored on the same area of the medium, Straight forward methods of increasing the optical resolution involve widening of the focused beam opening angle at the cost of lens complexity, narrowing of allowable disk tilt margins, etc. or reduction of the in-air wavelength i.e. changing the colour of the scanning laser.

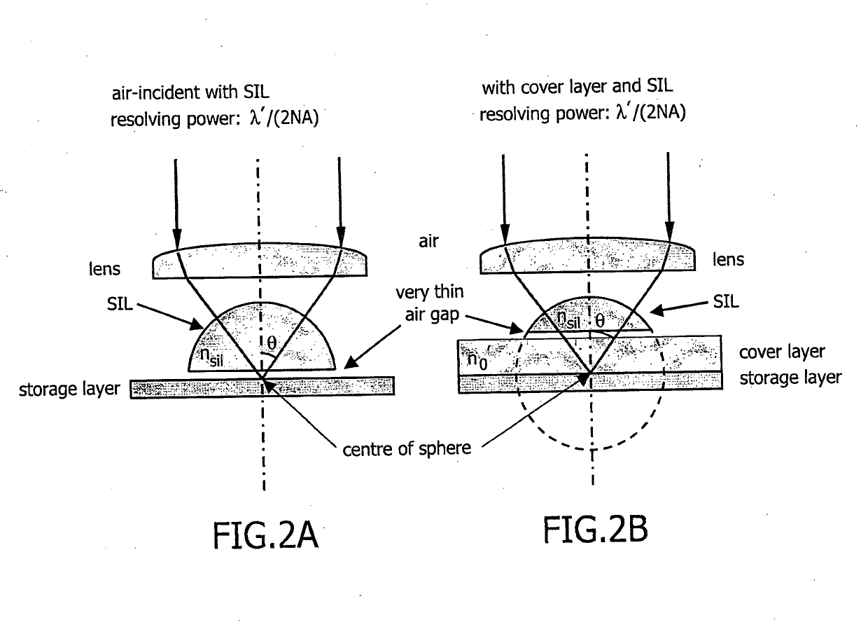

Another proposed method of reducing the focused spot size in an optical disk system involves the use of a solid immersion lens (SIL), see FIG. 2. In its simplest form, the SIL is a half sphere centred on the data storage layer, see FIG. 2A, so that the focussed spot is on the interface between SIL and data layer. In combination with a cover layer of the same refractive index, n₀′=n_{SIL}, the SIL is a tangentially cut section of a sphere which is placed on the cover layer with its (virtual) centre again placed on the storage layer, see FIG. 2B. The principle of operation of the SIL is that it reduces the wavelength at the storage layer by a factor n_{SIL}, the refractive index of the SIL, without changing the opening angle θ. The reason is that refraction of light at the SIL is absent since all light enters at right angles to the SIL's surface (compare FIG. 1B and FIG. 2A).

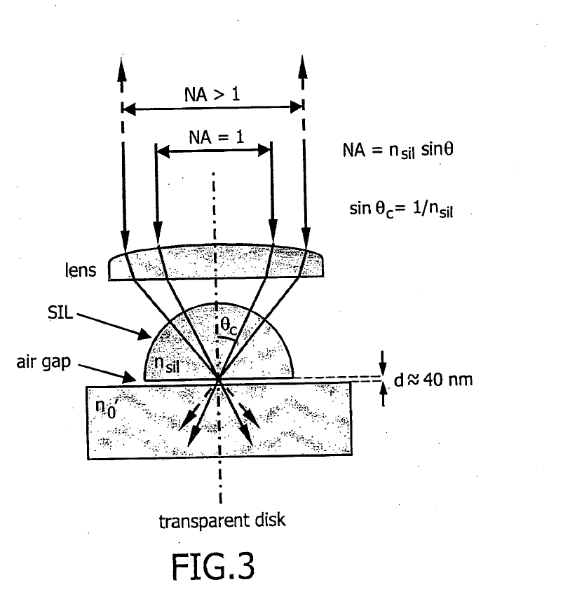

Very important, but not mentioned up until this point, is that there is a very thin air gap between SIL and recording medium. This is to allow for free rotation of the recording disk with respect to the recorder objective (lens plus SIL). This air gap should be much smaller than an optical wavelength, typically it should be smaller than λ/10, such that so-called evanescent coupling of the light in the SIL to the cover layer of the disc is still possible. The range over which this happens is called the near-field regime. Outside this regime, at larger air gaps, total internal reflection will trap the light inside the SIL and send it back up to the laser. Note that in case of the configuration with cover layer as depicted in FIG. 2B, that for proper coupling the refractive index of the cover layer should be at least equal to the refractive index of the SIL, see FIG. 3 for further details.

Waves below the critical angle propagate through the air gap without decay, whereas those above the critical angle become evanescent in the air gap and show exponential decay with the gap width. At the critical angle NA=1. For large gap width all light above the critical angle reflects from the proximate surface of the SIL by total internal reflection (TIR).

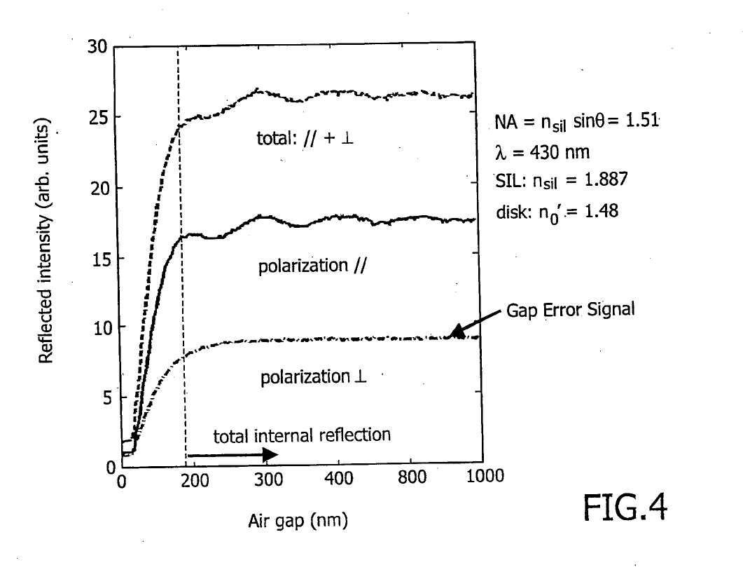

For a wavelength of 405 nm, which is the wavelength for Blu-Ray optical disc (BD), the maximum air-gap is approximately 40 nm, which is a very small free working distance (FVWD) as compared to conventional optical recording. The near-field air gap between data layer and the solid immersion lens (SIL) should be kept constant within 5 nm or less in order to get sufficiently stable evanescent coupling. In hard disk recording, a slider-based solution relying on a passive air bearing is used to maintain this small air gap. In optical recording, where the recording medium must be removable from the drive, the contamination level of the disk is larger and will require an active, actuator-based solution to control the air gap. To this end, a gap error signal must be extracted, preferably from the optical data signal already reflected by the optical medium. Such a signal can be found, and a typical gap error signal is given in FIG. 4. Note that it is common practice in case a near-field SIL is used to define the numerical aperture as NA=n_{SIL} sin θ, which can be larger than 1.

FIG. 4 shows a measurement, taken from Ref. [1], of the amounts of reflected light for both the parallel and perpendicular polarisation states with respect to the linearly polarised collimated input beam from a flat and transparent optical surface (“medium”) with a refractive index of 1.48. These measurements are in good agreement with theory. The evanescent coupling becomes perceptible below 200 nm: the light vanishes in to the “disc”, and the total reflection drops almost linearly to a minimum at contact. This linear signal may be used as an error signal for a closed loop servo system of the air gap. The oscillations in the horizontal polarisation are caused by the reduction of the number of fringes within NA=1 with decreasing gap thickness.

More details about a typical near-field optical disc system can be found in Ref. [2].

A root problem for optical recorder objectives, either slider-based or actuator-based, having a small working distance, typically less than 50 μm, is contamination of the optical surface closest to the storage medium occurs. This is caused by re-condensation of water, which may be desorbed from the storage medium because of the high surface temperature, typically 250° C. for Magneto Optical (MO) recording and 650° C. for Phase Change (PC) recording, resulting from the high laser power and temperature required for writing data in, or even reading data from the data recording layer. The contamination ultimately results in malfunctioning of the optical data storage system due to runaway of, for example, the servo control signals of the focus and tracking system. This problem is a.o. described in the filings and patents given in Refs. [3]-[5].

The problem becomes more severe for the following cases: high humidity, high laser power, low optical reflectivity of the storage medium, low thermal conductivity of the storage medium, small working distance and high surface temperature.

A known solution to the problem is to shield the proximal optical surface of the recorder objective from the data layer by a thermally insulating cover layer on the storage medium. An invention based on this insight is for example given in Ref. [4].

Obviously, putting a cover layer on the near-field optical storage medium has the additional advantage that dirt and scratches can no longer directly influence the data layer.

However, by putting a cover layer onto a near-field optical system, new problems arise, which lead to new measures to be taken.

Normally, the accuracy by which the near-field air gap, or free working distance, between data layer and the solid immersion lens (SIL) should be kept constant within 5 nm or less in order to get sufficiently stable evanescent coupling. In case a cover layer is used, the air gap is between cover layer and SIL, see FIG. 2B. Again, the air gap should be kept constant to within 5 nm. Clearly, the SIL focal length should have an offset to compensate for the cover layer thickness such as to guarantee that the data layer is in focus at all times. Note that the refractive index of the cover layer, if it is lower than the refractive index of the SIL, determines the maximum possible numerical aperture of the system.

In order to obtain sufficient thermal isolation, the dielectric cover layer thickness should be more than approximately 0.5 μm, but preferably is of the order of 2-10 μm.

It is an object of the invention to provide an optical data storage system for recording and reading of the type mentioned in the opening paragraph, in which reliable data recording and read out is achieved using a near-field solid immersion lens in combination with a cover layer. It is an further object to provide a method of optical recording and reading for such a system.

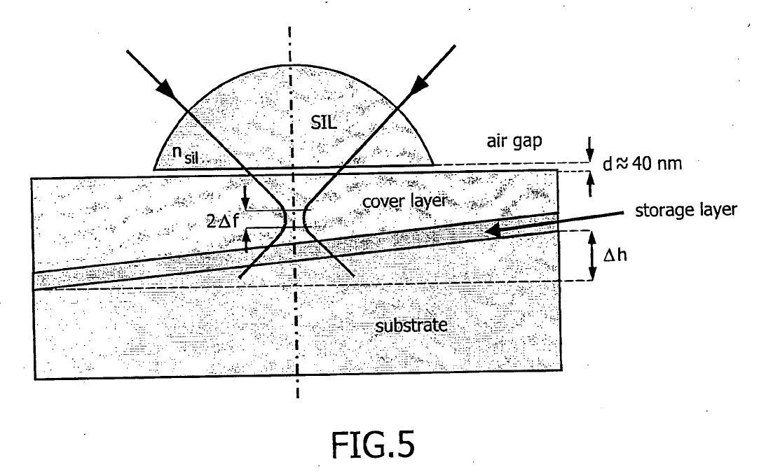

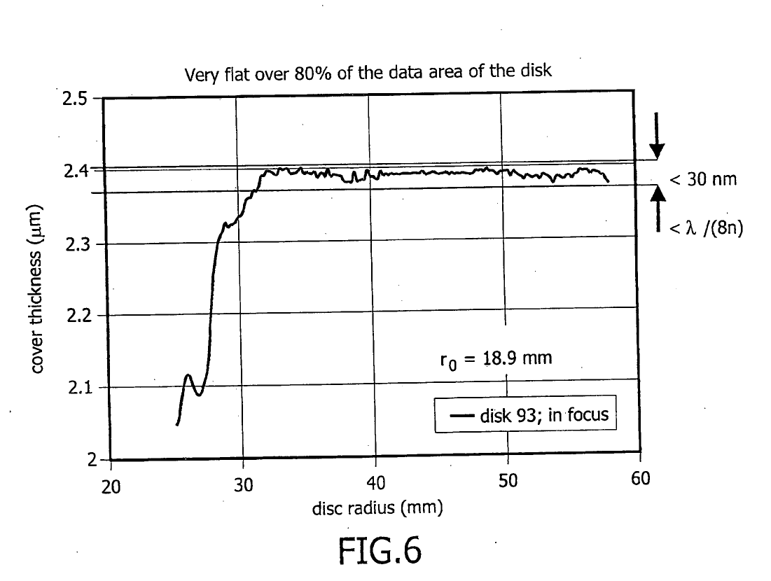

The first object has been achieved in accordance with the invention by an optical data storage system, which is characterized in that the thickness variation Δh of the cover layer over the whole medium is smaller than 50 nm. Preferably Δh is smaller than 20 nm. By only controlling the free working distance or the width of the air gap, the thickness variation of the cover layer Ah should be (much) smaller than the focal depth Δf=λ/(2NA²) in order to guarantee that the data layer is in focus: Δh<Δf, see FIG. 5. For the wavelength λ=405 nm and numerical aperture NA=1.45 it is found that Δf≈50 nm. For spin-coated layers of several microns thickness this means less than a percent of thickness variation over the entire data area of the disc, which seems a challenging accuracy. However, it surprisingly has appeared to be possible to make spin-coated layers with the required specifications: Several microns thickness and less than 30 nm thickness variation, see for example FIG. 6 and Refs. [6] and [7]. This result is remarkable since the fluid was not administered in the centre of the disk (since there is a hole), but at a radius of 18.9 mm. Usually this leads to a very inhomogeneous result, with the cover-layer thickness at the edges much higher than in the middle. In this case, however, a thermal gradient was used to tune the fluid viscosity during the spin process as a function of the disk radius.

Thus the first new insight is that near-field optical storage disks can be made with cover layers that have sufficiently small thickness variation Δh.

In an embodiment the optical head comprises:

a first adjustable optical element corresponding to the solid immersion lens

means for axially moving the first optical element in order to keep the free working distance between cover layer and solid immersion lens dynamically constant,

a second adjustable optical element,

means for adjusting the second optical element in order to change, with a low bandwidth, the position of the focal point of the focused radiation beam relative to an exit surface of the solid immersion lens. The low bandwidth adjustment of the focal length is performed mainly to compensate for drift, e.g. by temperature changes and to overcome manufacturing tolerances, e.g. between different discs and small radial thickness variations of the cover layer of the disc. The adjustment takes place over time scales of typically seconds rather than milliseconds, as is the case for the servo used in the means for axially moving the first optical element. Hence low bandwidth refers to time scales of typically seconds while high bandwidth refers to time scales of typically milliseconds or less.

The second new insight is that, given that the cover layer does have sufficiently small thickness variation Δh, say its thickness varies by less than 20-50 nm, we propose a static correction of focal length to compensate for cover layer thickness variations, in addition to the dynamic air gap, i.e. free working distance, correction.

The purpose is that the data storage layer is in focus and at the same time the air gap between the SIL and the cover layer is kept constant so that proper evanescent coupling is guaranteed. The position of the optical objective should be adjusted according to a gap error signal to maintain the gap width constant to within less than 5 nm, or preferably less than 2 nm.

A cover layer with thickness variation of substantially less than the focal depth eliminates the need of dynamic focus control of the objective which is otherwise required in addition to the gap servo. Only a static focus control and spherical aberration correction to accommodate possible disc-to-disc variance is desired. Also drift of any pre-set focal length due to mechanical shock or temperature effects can be compensated in this way. Focal length adjustment can be realised by optimising the modulation depth of a known signal, for example from a lead-in track.

A similar procedure is described in Ref. [8] for DVD focus optimisation.

Clearly, it is very advantageous to have a very flat cover layer on an optical data storage medium.

In an embodiment the second optical element is present in the objective.

In another embodiment the second optical element is present outside the objective.

The second optical element may e.g. be axially movable with respect to the first optical element. Alternatively the second optical element has a focal length which is electrically adjustable, e.g. by electrowetting or electrically influencing the orientation of liquid crystal material.

The further object has been achieved in accordance with the invention by a method of optical recording and/or reading with a system as claimed in claim 3, wherein:

the free working distance is kept constant by using a first, high bandwidth servo loop based on a gap error signal, e.g. derived from the amount of evanescent coupling between the solid immersion lens and the cover layer,

the first optical element is actuated based on the first servo loop,

a second, low bandwidth servo loop is active based on a focus control signal derived from the modulation depth of a modulated signal recorded in the data storage layer,

the second optical element is adjusted based on the second servo loop in order to retrieve an optimal modulated signal. The meaning of low bandwidth is explained above.

In an embodiment an oscillation is superimposed on the adjustment of the second optical element and wherein the focus control signal additionally is derived from the oscillation direction of the second optical element.

In another embodiment the modulated signal is recorded as recorded data in the optical data storage medium, e.g. in a lead-in area of the optical data storage medium.

In another embodiment the modulated signal is recorded as a wobbled track of the optical data storage medium.

The optical objective should contain at least two adjustable optical elements.

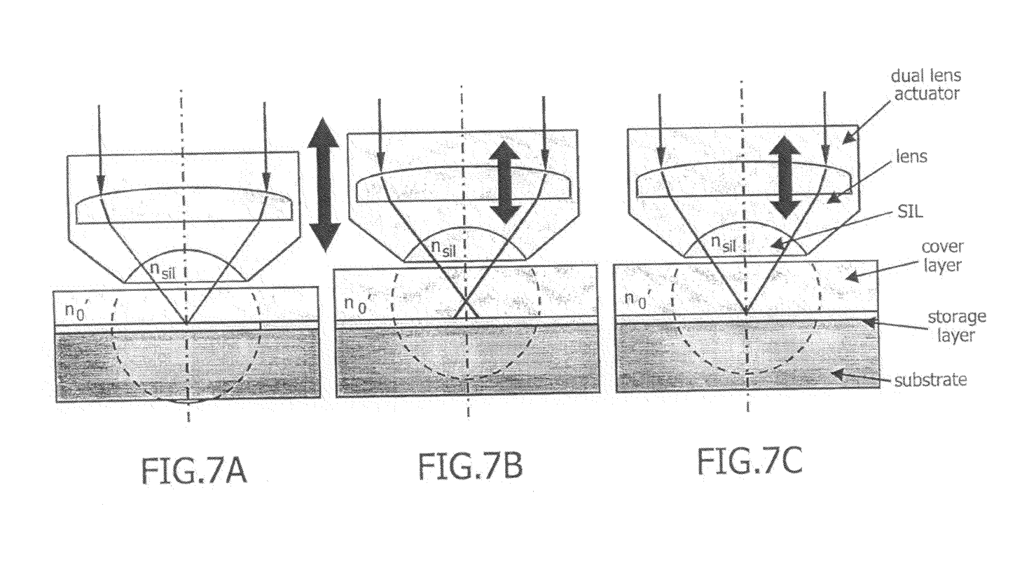

For example, an objective lens comprising two elements which can be axially displaced to adjust the focal length of the pair without substantially changing the air gap. The air gap can then be adjusted by moving the objective as a whole, (FIG. 7). In general, a certain amount of spherical aberration will remain. In some cases, optimum design of the lens system en cover layer combination will meet the system requirements, in other cases active adjustment of spherical aberration will be required and further measures will have to be taken.

The key advantage is that it is simpler. The required adjustment of the position the second optical element, i.e. lens, in the complete dual lens actuator (FIG. 7) is smaller and at lower bandwidth than is the case for the solution proposed in European patent application simultaneously filed by present applicant with reference number PHNL040461. In fact, the lens may be suspended in the actuator in such a way that its axial motion is super-critically damped.

In a preferred embodiment the modulation signal may come from a known wobble signal, in an alternative embodiment it may come from known pre-recorded data or, in case of a ROM system, it may even be special data on the lead-in track or even user data. See e.g. Ref. [8].

The invention will now be explained in more detail with reference to the drawings in which

FIGS. 1A and 1B show a normal far-field optical recording objective and data storage disk resp. without and with cover layer,

FIGS. 2A and 2B show a Near-Field optical recording objective and data storage disk resp. without and with cover layer,

FIG. 3 shows that total internal reflection occurs for NA>1 if the air gap is too wide,

FIG. 4 shows a measurement of the total amount of the reflected light for the polarisation states parallel and perpendicular to the polarisation state of the irradiating beam, and the sum of both,

FIG. 5 shows that the thickness variation of the cover layer may be larger or smaller than the focal depth,

FIG. 6 shows an example of a thickness profile of a spin-coated layer: a UV-curable silicone hard coat,

FIGS. 7A, 7B and 7C show the principle of operation of a dual actuator in case of varying disk-to-disk cover layer thickness,

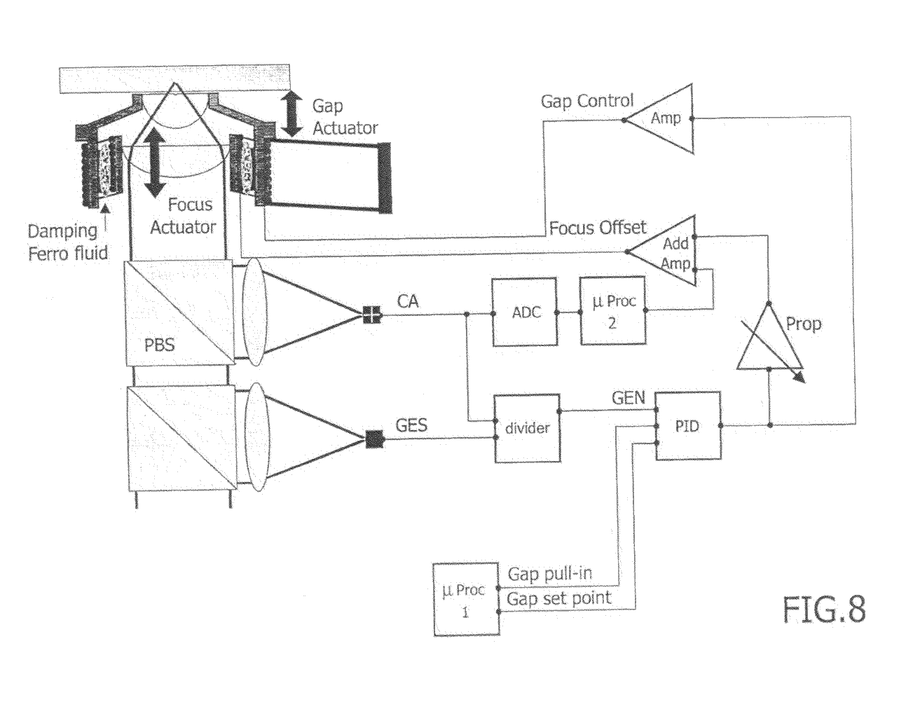

FIG. 8 shows a block diagram of the static focus control system required to drive the lens in the dual lens actuator,

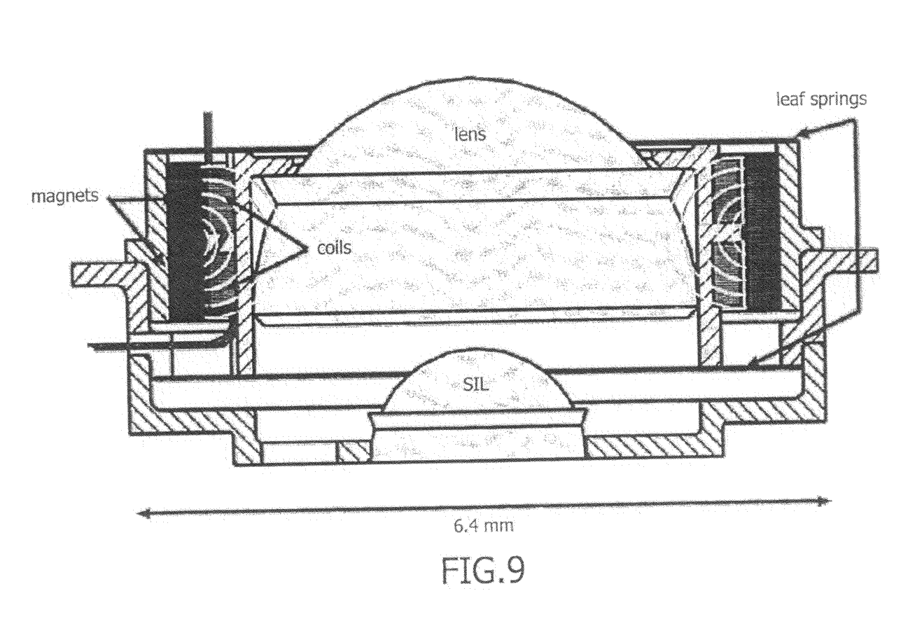

FIG. 9 shows a cross section of a possible embodiment of a dual lens actuator for near field.

FIG. 10 shows that defocus can be obtained by moving the lens with respect to the SIL using the Focus Control (FC). The air gap is kept constant using the Gap Control (GC),

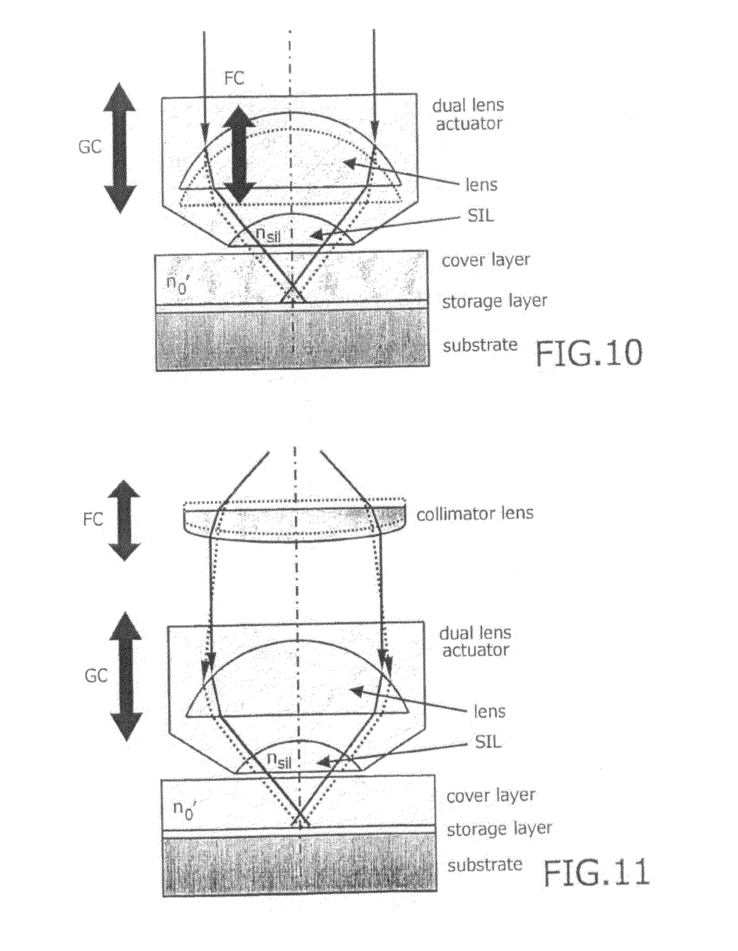

FIG. 11 shows that defocus also can be obtained by moving the laser collimator lens with respect to the objective,

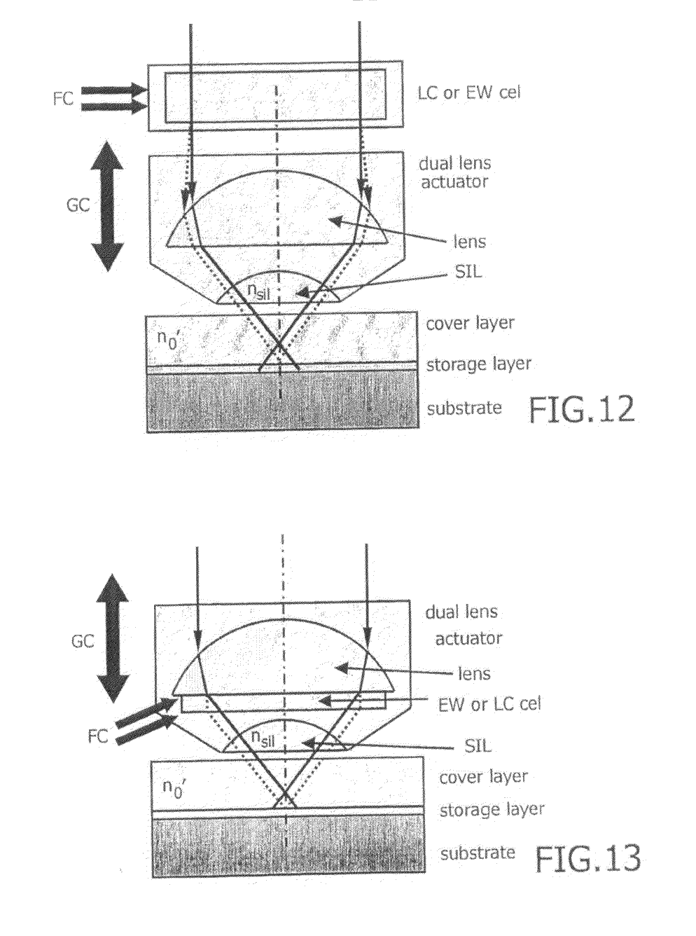

FIG. 12 shows an embodiment of a dual lens actuator wherein a switchable optical element based on electrowetting (EW) or liquid crystal (LC) material can be used to adjust the focal length of the optical system, and

FIG. 13 shows another embodiment as in FIG. 12 wherein the switchable optical element is placed between the first lens and the SIL.

In FIGS. 1A and 1B a normal far-field optical recording objective and data storage disk. Resp. without cover layer and with cover layer are shown.

In FIGS. 2A and 2B a Near-Field optical recording objective and data storage disk resp. without and with cover layer are shown. The effective wavelength is reduced to λ′=λ/n_{SIL}. The effective wavelength is reduced to λ′=λ/n₀′. The width of the air gap is typically 25-40 nm (but at least less than 100 nm), and is not drawn to scale. The thickness of the cover layer typically is several microns but is also not drawn to scale.

In FIG. 3 is shown that total internal reflection occurs for NA>1 if the air gap is too wide. If the air gap is thin enough, the evanescent waves make it to the other side and in the transparent disk become propagating again. Note that if the refractive index of the transparent disk is smaller than the numerical aperture, n₀′<NA, that some waves remain evanescent and that effectively NA=n₀′.

In FIG. 4 a measurement of the total amount of the reflected light for the polarisation states parallel and perpendicular to the polarisation state of the irradiating beam, and the sum of both is shown. The perpendicular polarisation state is suitable as an air-gap error signal for the near-field optical recording system.

In FIG. 5 is shown that the thickness variation of the cover layer may be larger or smaller than the focal depth. By only controlling the free working distance or the width of the air gap, the thickness variation of the cover layer Ah should be (much) smaller than the focal depth Δf=λ(2NA²) in order to guarantee that the data layer is in focus: Δh<Δf, see FIG. 5. If we take the wavelength λ=405 nm and numerical aperture NA=1.45 we find that Δf≈50 nm. For spin-coated layers of several microns thickness this means less than a percent of thickness variation over the entire data area of the disc, which seems a challenging accuracy. However, it surprisingly has appeared to be possible to make spin-coated layers with the required specifications: Several microns thickness and less than 30 nm thickness variation, see for example FIG. 6 and Refs. [6] and [7]. This result is remarkable since the fluid was not administered in the centre of the disk (since there is a hole), but at a radius of 18.9 mm. Usually this leads to a very inhomogeneous result, with the cover-layer thickness at the edges much higher than in the middle. In this case, however, a thermal gradient was used to tune the fluid viscosity during the spin process as a function of the disk radius.

In FIG. 6 an example of a spin-coated layer, a UV-curable silicone hard coat is shown. The cover layer is very flat over the outer 28 mm which represents already 80% of the data area.

In FIGS. 7A, 7B and 7C the principle of operation of a dual actuator in case of varying disk-to-disk cover layer thickness is shown. In FIG. 7A for a first disk with a certain cover layer thickness, the storage layer is in focus and the air gap is kept constant. In FIG. 7B for another disk, the cover layer thickness is different, and the data storage layer is out of focus. In FIG. 7C this is corrected where the first lens is displaced to regain focus on the storage layer.

In FIG. 8 a block diagram of the static focus control system required to drive the first lens in the dual lens actuator is shown. A gap actuator (GA) is used for control of the air gap. This gap actuator is fitted with a smaller focus actuator (FA) that is used to offset the focal position. The gap actuator is driven by a PID controller, using a normalised gap error signal (GEN) as input. This normalised gap error signal is generated by a divider that divides the gap error signal (GES) by the low frequency component of the Central Aperture (CA) signal or a signal from a forward sense diode. A controller set point and air gap pull-in procedure is fed into the controller by a central microprocessor (μProc1).

The position of the lens, i.e. the second optical element, with respect to the SIL, i.e. the first optical element, is adjusted such that the CA signal modulation of a pre-recorded data pattern or a wobble signal is largest. The CA signal is sampled by an Analogue to Digital Converter (ADC) and then fed into a microprocessor (μProc2) which during an initialisation phase runs a procedure to find the optimum focus offset signal by trial and error: The focus position is changed such that an optimum signal is obtained. To keep the distance between the lens and the SIL constant, after the initialisation phase, during acceleration of the Gap Actuator a signal proportional to the Gap Actuator error signal is added to the offset signal, amplified with a current amplifier and then fed into the over-critically damped focus actuator.

Two control signals are required:

The width of the air gap can be controlled using an error signal derived from the amount of evanescent coupling between SIL and cover layer. In FIG. 4 a typical gap error signal (GES) is shown

A focus control signal (FCS) can be derived from the modulation depth of e.g. a lead-in track on the disk which contains some known signal.

In FIG. 9 a cross section of a possible embodiment of a dual lens actuator for near field is shown.

In FIG. 10 an optical data storage system for recording and/or reading, using a radiation beam e.g. a laser beam having a wavelength λ=405 nm is shown. The radiation beam is focused onto a data storage layer of an optical data storage medium. Said system comprises:

the medium (cover layer, storage layer and substrate), having a cover layer that is transparent to the focused radiation beam, said cover layer having a thickness h smaller than 5 μm, e.g. 3 μm.

an optical head, including an objective (dual lens actuator) having a numerical aperture NA, said objective including a solid immersion lens (SIL) that is adapted for being present at a free working distance of smaller than λ/10 from an outermost surface of said medium and arranged on the cover layer side of said optical data storage medium, and from which solid immersion lens the focused radiation beam is coupled by evanescent wave coupling into the cover layer of the optical data storage medium during recording/reading. The thickness variation Δh of the cover layer over the whole medium is 30 nm which is smaller than 50 nm. The optical head comprises:

a first adjustable optical element: the solid immersion lens (SIL),

means for axially moving the first optical element in order to keep the distance between cover layer and solid immersion lens dynamically constant,

a second adjustable optical element: lens,

means, see coils in FIG. 9, for adjusting the second optical element in order to change, with a low bandwidth, the position of the focal point of the focused radiation beam relative to an exit surface of the solid-immersion lens. Because the variation Δh of the thickness of the cover layer is below 50 mm only one servo loop is required for the air gap, which makes the proximate surface of the optical objective follow the surface of the cover layer and one static optimisation loop is required for the focal length, which keeps the data layer to within the focal depth by varying the focal length of the optical objective. Defocus can be obtained by moving the lens with respect to the SIL using the Focus Control (FC). The air gap is kept constant using the Gap Control (GC).

In FIG. 11 is shown that defocus also can be obtained by moving the laser collimator lens with respect to the objective.

In FIG. 12 a switchable optical element based on electrowetting (EW) or liquid crystal (LC) material, that can be used to adjust the focal length of the optical system, is shown. It is also possible to simultaneously compensate for a certain amount of spherical aberration in this way.

In FIG. 13 a switchable optical element based on electrowetting or liquid crystal material can be used to adjust the focal length of the optical system is shown. Here the element is placed between the lens and the SIL. It is also possible to simultaneously compensate for a certain amount of spherical aberration in this way.

Embodiments of the optical part of this invention are the same as those described in European patent application simultaneously filed by present applicant with reference number PHNL040461.

A dual lens actuator has been designed, which has a Lorentz motor to adjust the distance between the two lenses within the recorder objective. The lens assembly as a whole fits within the CDM12 actuator. The dual lens actuator consists of two coils that are wotuid in opposite directions, and two radially magnetised magnets. The coils are wound around the objective lens holder and this holder is suspended in two leaf springs. A current through the coils in combination with the stray field of the two magnets will result in a vertical force that will move the first objective lens towards or away from the SmL. A near field design may look like the drawing in FIG. 9. In this design a Ferro-fluid (a kind of magnetic oil) between coils and magnets is used to dampen the motion of the first lens such that resonances are fully surpressed, see Ref [9].

A first embodiment of an optical objective with variable focal position is shown in FIGS. 7 and 9, and it is repeated in FIG. 10. Alternative embodiments to change the focal position of the system comprise, for example, adjustment of the laser collimator lens, see FIG. 11, or a switchable optical element based on electrowetting or liquid crystal material, see FIGS. 12 and 13 and also Ref. [9]. These measures, of course, can be taken simultaneously.

### REFERENCES

[1] Ferry Zijp and Yourii V. Martynov, “Static tester for characterization of optical near-field coupling phenomena”, in Optical Storage and Information Processing, Proceedings of SPIE 4081, pp. 21-27 (2000).
[2] Kimihiro Saito, Tsutomu Ishimoto, Takao Kondo, Ariyoshi Nakaoki, Shin Masuhara, Motohiro Furuki and Masanobu Yamamoto, “Readout Method for Read Only Memory Signal and Air Gap Control Signal in a Near Field Optical Disc System”, Jpn. J. Appl. Phys. 41, pp. 1898-1902 (2002).
[3] Martin van der Mark and Gavin Phillips, “(Squeaky clean) Hydrophobic disk and objective”, (2002); see international patent application publication WO 2004/008444-A2 (PHNL0200666).
[4] Bob van Sonieren; Ferry Zijp; Hans van Kesteren and Martin van der Mark, “Hard coat protective thin cover layer stack media and system”, see international patent application publication 2004/008441-A2 (2002) (PHNL0200667).
[5] TeraStor Corporation, San Jose, Calif., USA, “Head including a heating element for reducing signal distortion in data storage systems”, U.S. Pat. No. 6,069,853.
[6] F. Zijp, R. J. M. Vullers, H. W. van Kesteren, M. B. van der Mark, C. A. van den Heuvel, B. van Someren, and C. A. Verschuren, “A Zero-Field MAMMOS recording system with a blue laser, NA=0.95 lens, fast magnetic coil and thin cover layer”, OSA Topical Meeting: Optical Data Storage, Vancouver, 11-14 May 2003.
[7] Piet Vromans, ODTC, Philips, see international patent application publication WO 2004/064055-A1.
[8] Wim Koppers, Pierre Woerlee, Hubert Martens, Ronald van den Oetelaar and Jan Bakx, “Finding the optimal focus-offset for writing dual layer DVD+R/+RW: Optimised on pre-recorded data”, (2002), see international patent application publication WO 2004/086382-A1.
[9] B. J. Feenstra, S. Kuiper, S. Stalling a, B. H. W. Hendriks, R. M. Snoeren, “Variable focus lens”, see international patent application publication WO 2003/069380-A1. S. Stalling a, “Optical scanning device with a selective optical diaphragm”, U.S. Pat. No. 6,707,779 B1.

1. An optical data storage system for recording and/or reading, using a radiation beam having a wavelength λ, focused onto a data storage layer of an optical data storage medium, said system comprising:
the medium, having a cover layer that is transparent to the focused radiation beam, said cover layer having a thickness h smaller than 5 μm,
an optical head, including an objective having a numerical aperture NA, said objective including a solid immersion lens that is adapted for being present at a free working distance of smaller than λ/10 from an outermost surface of said medium and arranged on the cover layer side of said optical data storage medium, and from which solid immersion lens the focused radiation beam is coupled by evanescent wave coupling into the cover layer of the optical data storage medium during recording/reading,
characterized in that,
the thickness variation Δh of the cover layer over the whole medium is smaller than 50 nm.

2. An optical data storage system as claimed in claim 1, wherein Δh is smaller than 20 nm.

3. An optical data storage system as claimed in any one of claims 1 or 2, wherein the optical head comprises:
a first adjustable optical element corresponding to the solid immersion lens
means for axially moving the first optical element in order to keep the distance between cover layer and solid immersion lens dynamically constant,
a second adjustable optical element,
means for adjusting the second optical element in order to change, with a low bandwidth, the position of the focal point of the focused radiation beam relative to an exit surface of the solid immersion lens.

4. An optical data storage system as claimed in claim 3, wherein the second optical element is present in the objective.

5. An optical data storage system as claimed in claim 3, wherein the second optical element is present outside the objective.

6. An optical data storage system as claimed in claims 4 or 5, wherein the second optical element is axially movable with respect to the first optical element.

7. An optical data storage system as claimed in any one of claims 4 or 5, wherein the second optical element has a focal length which is electrically adjustable, e.g. by electrowetting or electrically influencing the orientation of liquid crystal material.

8. A method of optical recording and/or reading with a system as claimed in claim 3, wherein:
the free working distance is kept constant by using a first, high bandwidth servo loop based on a gap error signal, e.g. derived from the amount of evanescent coupling between the solid immersion lens and the cover layer,
the first optical element is actuated based on the first servo loop,
a second, low bandwidth servo loop is active based on a focus control signal derived from the modulation depth of a modulated signal recorded in the data storage layer,
the second optical element is adjusted based on the second servo loop in order to retrieve an optimal modulated signal.

9. A method as claimed in claim 8, wherein an oscillation is superimposed on the adjustment of the second optical element and wherein the focus control signal additionally is derived from the oscillation direction of the second optical element.

10. A method as claimed in claim 8, wherein the modulated signal is recorded as recorded data in the optical data storage medium.

11. A method as claimed in claim 8, wherein the modulated signal is recorded in a lead-in area of the optical data storage medium.

12. A method as claimed in claim 8, wherein the modulated signal is recorded as a wobbled track of the optical data storage medium.
